(19) United States
(12) Patent Application Publication
(10) Pub. No.: US 2024/0220540 A1
(43) Pub. Date: Jul. 4, 2024

(54) SYSTEMS AND METHODS FOR REACHABILITY OF DIFFERENT DESTINATIONS

(71) Applicant: VIA TRANSPORTATION, INC., New York, NY (US)

(72) Inventors: Raja GANGOPADHYA, Oakland, CA (US); Caitlin HEWITT PROCTOR, San Francisco, CA (US); Hari NARAYANAN, Oakland, CA (US); Stuart CAMPBELL, Kensington (AU); Minh Quan HUYNH, Oakland, CA (US); Krithin SITARAM, San Francisco, CA (US); Yeying HUANG, San Francisco, CA (US); Rebekah WATKINS, Castro Valley, CA (US)

(73) Assignee: VIA TRANSPORTATION, INC., New York, NY (US)

(21) Appl. No.: 18/425,279

(22) Filed: Jan. 29, 2024

Related U.S. Application Data
(60) Provisional application No. 63/398,662, filed on Aug. 17, 2022.

(51) Int. Cl. G06F 16/901; G06F 16/29; G06Q 50/40

(52) U.S. Cl. CPC G06F 16/9024; G06F 16/29; G06Q 50/40

(57) ABSTRACT

A system and method for predicting stats for different destinations is provided. The system and method can include receiving a dataset of stats in a spatial format and a request for stats in a geographical area. The system and method can include determining a grid of cells based on the geographical area, determining an origin point in each cell in the grid of cell, determining a graph based on the grid of cells, determining a proportion of the stat to assign to each node, edge or both in the graph in the geographical area based on an overlap between the dataset of stats and the graph, and determining a total for the stat for the geographical area.

### FIELD OF THE INVENTION

The invention relates generally to systems for geographical statistical determinations for various destinations and planning.

### BACKGROUND OF THE INVENTION

Access to destinations and/or resources can be among important outcomes to plan transit around. For example, access to jobs, doctors, hospitals, grocery stores, restaurants, schools, and/or daycares can impact quality of life for populations.

Planning tools can be used to analyze geographical locations and design and/or modify transportation networks to assist populations in having greater accessibilities and/or serving the most people in the population. Typically, large investments are made in funding transportation networks, thus accurate planning is important.

Current planning tools suffer from a variety of problems, including inaccuracies, incomplete information and/or slow operation.

Therefore, it can be desirable to provide planning that is accurate, has complete information, and/or that is able to perform in a realizable amount of time and/or in real-time.

### SUMMARY

Advantages of the invention can include planning that is accurate, has complete information, and/or that is able to perform in a realizable amount of time and/or in real-time. Advantages can also include improved speed due to a less expensive calculation in comparison to prior methods.

In one aspect, the invention involves a method for predicting stats for different destinations. The method can also involve receiving, by a computing device, a dataset of stats in a spatial format and a request for at a stat, the request including a geographical area. The method can also involve determining, by the computing device, a grid of cells based on the geographical area. The method can also involve determining, by the computing device, an origin point in each cell in the grid of cells. The method can also involve determining, by the computing device, a graph based on the grid of cells, wherein the graph is a collection of nodes and edges based on the origin points in each cell in the grid of cells and vector map data. The method can also involve determining, by the computing device, a proportion of the stat to assign to each node, edge or both in the geographical area based on an overlap between the dataset of stats and the graph. The method can also involve determining, by the computing device, a total for the stat for the geographical area. The method can also involve transmitting, by the computing device, the graph, and the total to a display.

In some embodiments, the request further comprises a time of day, duration for a trip, one or more mode of transportation or any combination thereof. In some embodiments, the method involves determining an upper bound for each cell in the grid of cells, wherein the upper bound is a maximum distance from the origin point that can be reached in the respective cell.

In some embodiments, the cell is a hexagonal cell. In some embodiments, the method further involves determining for each origin point in each cell, a duration to get to every other node in the graph. In some embodiments, the vector map data is retrieved at a predetermined zoom level. In some embodiments, the stat is user selectable. In some embodiments, the method further involves receiving a plurality of stats, wherein the stat and the plurality of stats include social, economical, demographic, or location based stats. For example, the plurality of stats can include population count, jobs count, percentage of a population under poverty line, percentage of population in particular age group, percentage of population that is part of a particular ethnicity, or any combination thereof.

In some embodiments, the invention includes a system for predicting stats for different destinations. The system can include a processor configured to receive a dataset of stats in a spatial format and a request for at a stat, the request including a geographical area. The processor can be configured to determine a grid of cells based on the geographical area, and determine an origin point in each cell in the grid of cells. The processor can be configured to determine a graph based on the grid of cells, wherein the graph is a collection of nodes and edges based on the origin points in each cell in the grid of cells and vector map data. The processor can be configured to determine a proportion of the stat to assign to each node, edge or both in the geographical area based on an overlap between the dataset of stats and the graph. The processor can be configured to determine a total for the stat for the geographical area and transmit the graph, and the total to a display.

In some embodiments, the request further comprises a time of day, duration for a trip, one or more mode of transportation or any combination thereof. In some embodiments, the processor is further configured to determine an upper bound for each cell in the grid of cells, wherein the upper bound is a maximum distance from the origin point that can be reached in the respective cell. In some embodiments, the cell is a hexagonal cell.

In some embodiments, the processor is further configured to determine for each origin point in each cell, a duration to get to every other node in the graph. In some embodiments, the vector map data is retrieved at a predetermined zoom level. In some embodiments, the stat is user selectable.

In some embodiments, the processor is further configured to receive a plurality of stats, wherein the stat and the plurality of stats include population count, jobs count, percentage of a population under poverty line, percentage of population in particular age group, percentage of population that is part of a particular ethnicity, or any combination thereof.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a diagram of a system architecture for predicting stats for different destinations, according to some embodiments of the invention.

FIG. 2 is a flowchart for a method for predicting stats for different destinations, according to some embodiments of the invention.

FIG. 3 shows an example of a user interface displaying a geographical region with transit lines indicated, according to some embodiments of the invention.

FIG. 4 shows an example of the user interface of FIG. 3 with a geographical area 400 selected within the geographical region, according to some embodiments of the invention.

FIG. 5 is an example of the user interface of FIG. 4 with the selected geographical area with a hexagonal grid of cells, according to some embodiments of the invention.

FIG. 6A shows a portion of the geographical area that overlaps with a portion of a spatial location of a polygon dataset of stats, according to some embodiments of the invention.

FIG. 6B shows a proportion of a polygon dataset of stats assigned to each edge in the portion of the geographical area of FIG. 6A, that overlaps with the portion of the spatial location, according to some embodiments of the invention.

FIG. 6C shows an example of a total for the stat for the geographical area of FIG. 6B, according to some embodiments of the invention.

FIG. 7A and FIG. 7B show examples of a geographical area with a point feature of a hospital, and moving the hospital to a vector map data segment, according to some embodiments of the invention.

FIG. 7C is an example of a display showing the stat of jobs accessible where the trip starts in the cell in a particular geographical region, according to some embodiments of the invention.

FIG. 7D is an example of the display of FIG. 7C with the stat of hospitals accessible where the trip starts in the same cell in the particular geographical region, according to some embodiments of the invention.

FIG. 8 shows a block diagram of a computing device 800 which can be used with embodiments of the invention.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

In general, a system and method for predicting stats for different destinations is provided. In general, the system and method can be described as determining for a theoretical person (e.g., avatar Jane as can be displayed to a user) at a user defined starting position, various statistics can be determined for Jane's reachability to various destinations. For example, it can be desirable to determine how far Jane can go in an urban center in 30 minutes or 45 minutes, how many jobs are reachable for Jane, how many grocery stores, and/or any statistic analysis (or data item analysis) as is desired.

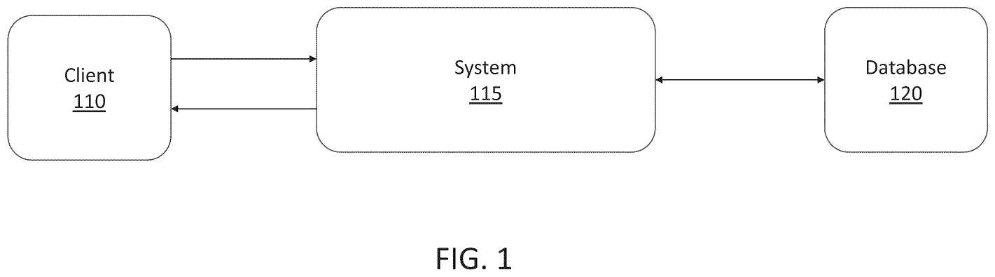

FIG. 1 is a diagram of a system architecture 100 for predicting stats for different destinations, according to some embodiments of the invention. The system architecture 100 can include a client 110, system 115 having multiple parallel workers running analysis, and a database 120. The client 110 can transmit requests (e.g., request for stat analysis for a particular geographical region) for analysis to the system 115. The system can retrieve data (e.g., data related to the geographical region and analysis) from a database 120.

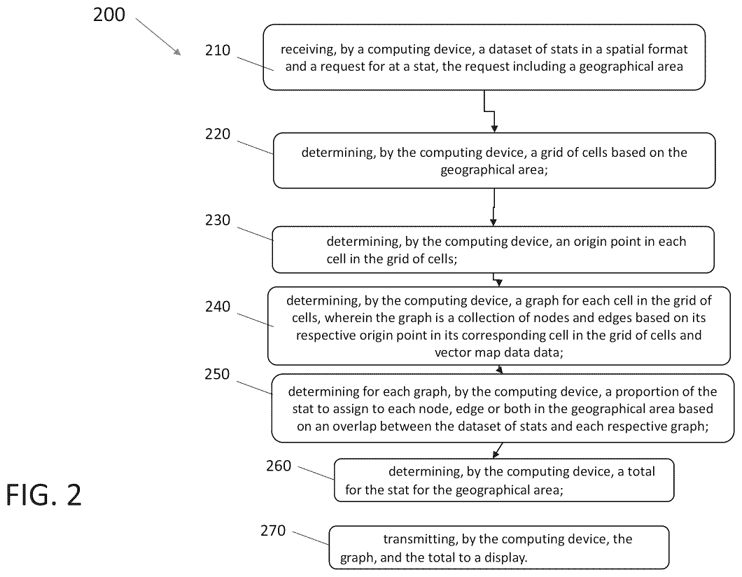

FIG. 2 is a flowchart for a method 200 for predicting stats for different destinations, according to some embodiments of the invention.

The method can involve receiving a dataset of stats (e.g., from the database 120 as described above in FIG. 1) in a spatial format and a request for at a stat (e.g., from the client 110 as described above in FIG. 1), the request including a geographical area (Step 210).

The dataset of stats can be stats related to any information related to the spatial format. For example, the dataset of stats can include public transportation, public transportation type and public transportation location, community assets, available jobs and corresponding locations, doctors and corresponding locations, supermarkets and corresponding locations, population, percentage of population in poverty, number of senior citizens, number of youths, percentage of car-free households, or any combination thereof. In some embodiments, points based stats can include hospitals, parks, schools, universities, garages, bike lockers and/or other metrics related to locations.

The spatial format of the dataset of stats can be polygonal. The polygonal data can be GeoJson or Shapefile. The dataset of stats can be input by a user, received by another system, or any combination thereof. In various embodiments, the dataset of stats is received in a format other than a GeoJson or Shapefile and the method involves converting the dataset of stats into a GeoJson or Shapefile.

The spatial format of the dataset of stats can be point features. For example, a point of interest (e.g., hospital, police station, etc.).

The dataset of stats can be for a particular geographical region.

The dataset of stats can be input by a user, e.g., a particular entity that desires the analysis be performed. For example, the dataset of stats can be for a city, municipality, public transit system and/or country region. The dataset of stats can be and/or include publicly available data (e.g., census data), private data, or any combination thereof.

The dataset of stats can be received from connected external systems.

In some embodiments, the dataset of stats is stored in a memory.

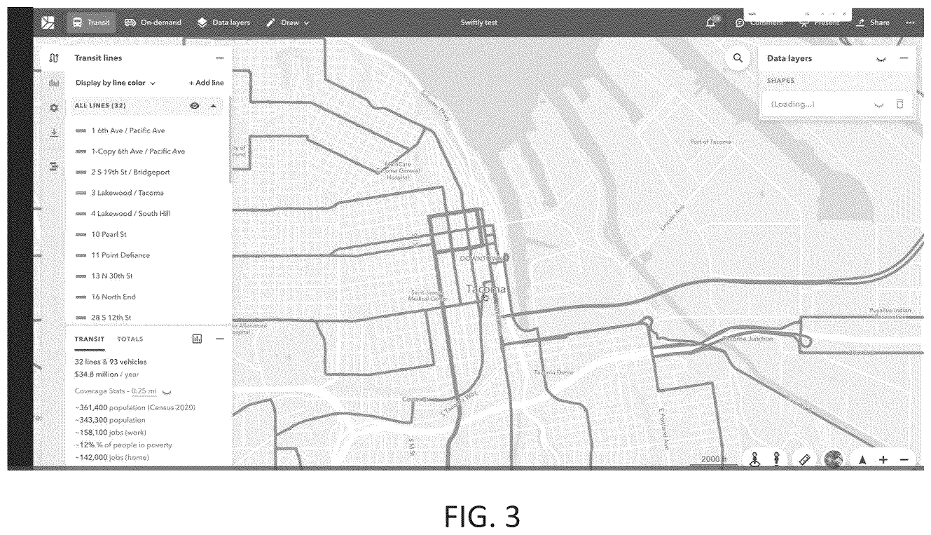

The geographical area can be input by a user via a user interface. The geographical area can be input by a user via a drag and drop function. For example, turning to FIG. 3, FIG. 3 shows an example of a user interface displaying a geographical region with transit lines indicated, according to some embodiments of the invention.

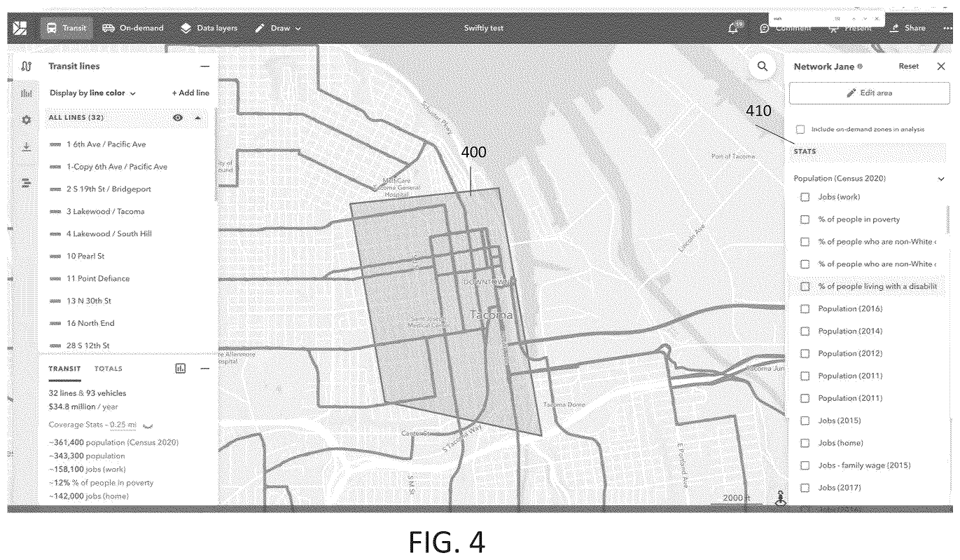

FIG. 4 shows an example of the user interface of FIG. 3 with a geographical area 400 selected within the geographical region, according to some embodiments of the invention. FIG. 4 also includes a drop down menu 410 of stats. The drop down menu of stats displays the available stats that can be selected. The available stats can correlate to the stats that are available in the dataset of stats, publicly available stats, stored stats or any combination thereof. A request for a stat (or multiple stats) for analysis can be made by selecting of one or more stats from the drop down menu. In this manner, stats available in the drop down menu can vary.

In some embodiments, the request can include a time of day, duration for a trip, one or more modes of transportation for a trip. In this manner, the method can accommodate a variety of requests. For example, a request can be made for grocery stores within a 30 minute travel distance from each origin (or any combination of origins) at noon.

In some embodiments, the request includes a reachability request such that walkability of a type of destination in a particular time period is requested.

A request can be made for libraries within a 20 minute walk at 3 pm. As is apparent to one of ordinary skill in the art, any combination of inputs described herein can be presented, based on the dataset of stats available and/or input configuration. In some embodiments, if an invalid combination of inputs is selected and error can be displayed to a user.

Turning back to FIG. 2, the method can also involve determining (e.g., via the system 115 as described above in FIG. 1) a grid of cells based on the geographical area (Step 220). The grid of cells can be a hexagonal grid of cells that overlaps with the geographical area. The grid of cells can be determined based on H3 open source.

In some embodiments, the grid of cells are square, circle, and/or any shape as is known in the art.

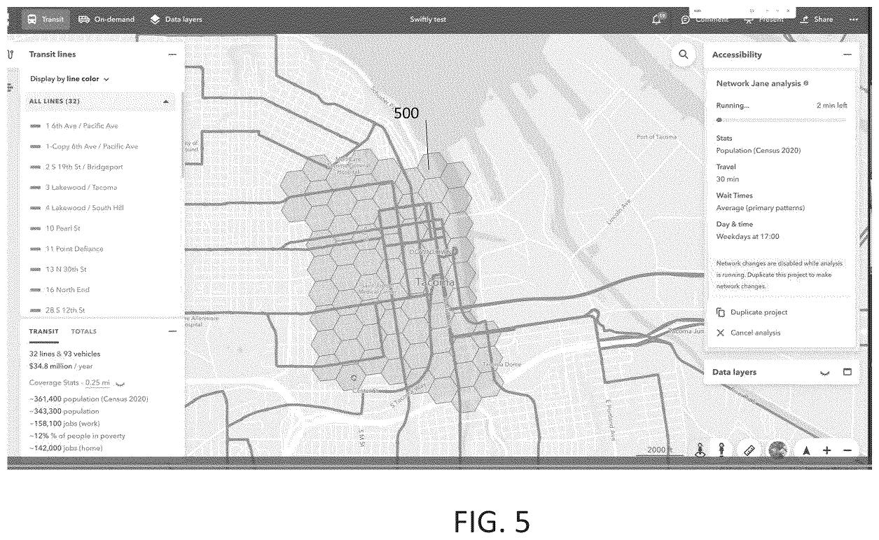

Turning to FIG. 5, FIG. 5 is an example of the user interface of FIG. 4 with the selected geographical area with a hexagonal grid of cells 500, according to some embodiments of the invention.

Turning back to FIG. 2, the method can also involve determining (e.g., via the system 115 as described above in FIG. 1) an origin point in each cell in the grid of cells (Step 230). The origin point can be a center point (e.g., centroid) in each cell.

In some embodiments, the method involves determining an upper bound for each cell in the grid of cells. The upper bound can be for each hex cell the maximum distance that can be traversed within the time duration (e.g., a time duration as specified by a user). The upper bound can be determined using Dijkstra algorithm. For example, the Dijkstra algorithm can be used to figure out how big of an area to analyze (e.g., what specific street segments to include in the analysis and a subsequent vector map data stat assignment). The inputs to the Dijkstra algorithm can include all of the cell origin points and a relevant portion of the transit network (e.g., geographic data).

In some embodiments, the Dijkstra algorithm is used to traverse the transit network with an assumption of “straight-line” walking from the transit stops. In some embodiments, a determination of how far of a distance that can be traversed is made, which can be an overestimation (e.g., since straight-line walking is typically always further than walking through an actual street network). The overestimation can be the upper bound.

The method can also involve determining (e.g., via the system 115 as described above in FIG. 1), a graph for each cell in the grid of cells, wherein each graph is a collection of nodes and edges based on its respective origin point in its corresponding cell in the grid of cells and vector map data (Step 240). For example, one or more nodes can be an intersection of streets. Vector map data can represent street segments as edges and their meeting points as nodes. In some embodiments, a street block between two stop signs can be an edge.

In various embodiments, the vector map data is roadway data, transit line data, and/or walkable walking paths. In some embodiments, the vector map data is OSM data.

The vector map data can be retrieved from a database. The vector map data can be, as is known in the art, from publicly available databases. In some embodiments, for example, demographic data can be at the block level. In various embodiments, the vector map data is retrieved at a zoom level based on a population level of the area within the geographical area. For example, in an urban environment the zoom level can be higher, whereas in a rural environment the zoom level can be lower.

The method can also involve determining how long it takes to get from each origin point of each hex cell to each node in the graph. The determination can be made via a Dijkstra algorithm.

The method can also involve determining for each graph (e.g., via the system 115 as described above in FIG. 1) a proportion of the stat to assign to each edge in the geographical area based on an overlap between the dataset of stats and each respective graph (Step 250). In some embodiments, where more than one stat is selected, the method can involve for each selected stat, determining a portion of the stat to assign to each node, edge or both in the geographical area.

Once all of the stats are collected for each graph, an average can be used to determine a final set of stats.

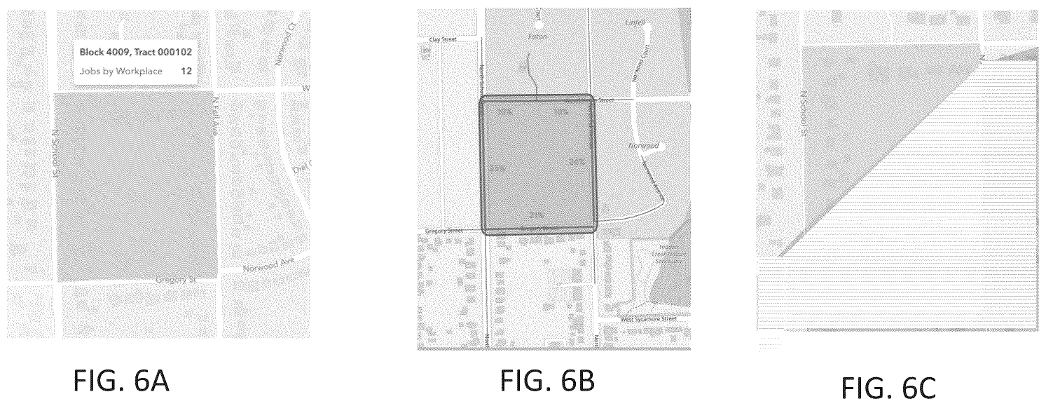

For example, assume an example of request to determine a stat of accessibility to jobs in a geographical area (e.g., a geographical area as selected by a user) for a polygon dataset of stats having the stat of jobs. Turning to FIGS. 6A and 6B, FIG. 6A shows a portion of the geographical area that overlaps with a portion of the spatial location of the polygon dataset of stats with 12 jobs and FIG. 6B shows a proportion of the polygon dataset of stats assigned to each edge in the portion of the geographical area that overlaps with the portion of the spatial location, according to some embodiments of the invention.

The geographical area can be selected such that it substantially overlaps with the spatial location of the polygon dataset of stats. In some embodiments, a buffer can be included, the buffer can be a portion of the geographical area that does not overlap with the spatial location of the polygon dataset of stats but that is included to ensure that street segments which travel along a boundary of a polygon feature are considered. The buffer distance can be input by a user, for example, 15 meters.

For the spatial location polygon dataset of stats of the 12 jobs there are 14 relevant edges (e.g., street segments) in the geographical area. Each edge goes between two intersections, no matter how small it may be, e.g. the tiny segment of North Fell Ave between Gregory and Norwood is considered an edge. Edges can be determined based on what streets “touch” the buffer area. The percentages can be the particular segment's length compared to the total length of all segments touched by the buffer area. For example, if all segments inside the buffer area add up to 200 m, and the part of North School Street inside the buffer area is 50 m, then 25% can be assigned to that edge. Subsequently, this edge can have assigned 25% of the stat value assigned to the original dataset feature.

FIG. 6B shows the percentage of the 12 jobs that belong to each segment.

Turning back to FIG. 2, the method can also involve determining (e.g., via the system 115 as described above in FIG. 1) a total for the stat for the geographical area (Step 260). For example, continuing with the example above in FIG. 6B, turning to FIG. 6C, where the inquiry is how many of the jobs are accessible, 7% of N. School street is accessible as shown by the line pattern section 610, all of Gregory St., and 95% of N. Fell Ave. Thus, (25%*12)*7%+(20%*12)*100%+(24%*12)*95%=5.35 jobs out of the 12 jobs are accessible.

The method can also involve determining transmitting, by the computing device, the graph, and the total to a display (Step 270).

For example, assume an example of request to determine a stat of accessibility to jobs in a geographical area (e.g., a geographical area as selected by a user) for a polygon dataset of stats having the stat of jobs.

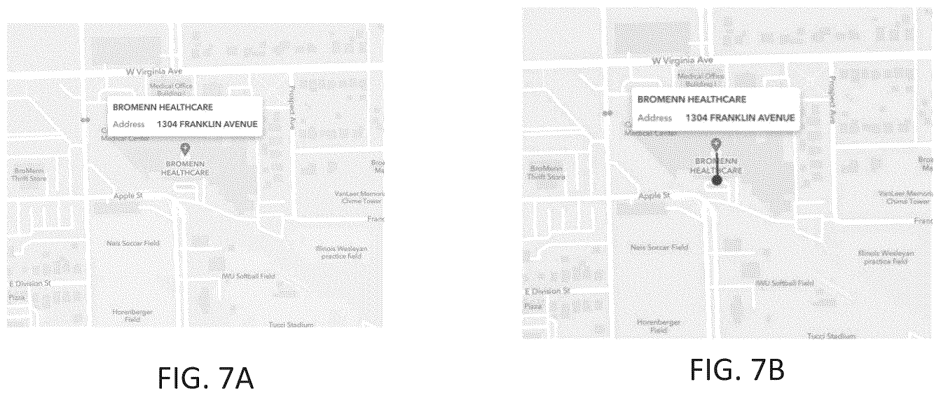

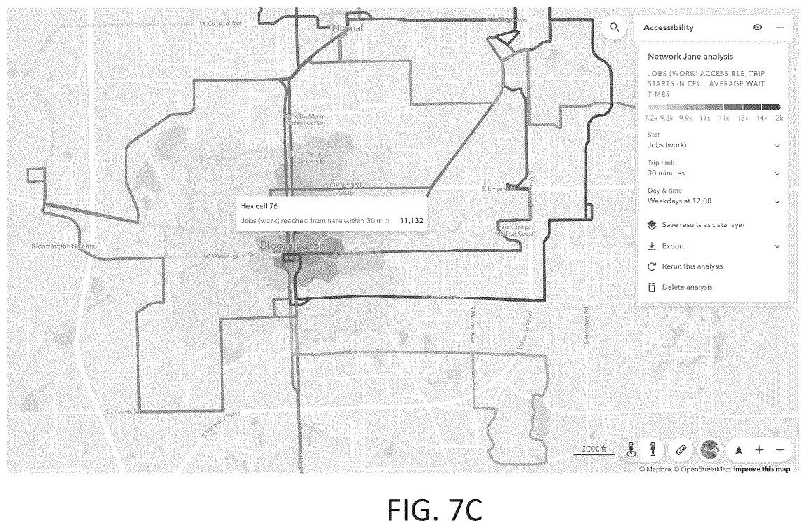

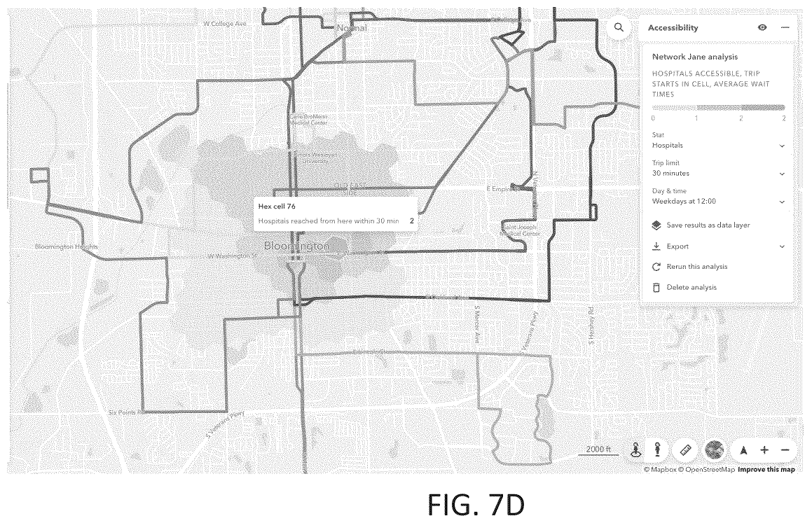

In some embodiments, the dataset of stats includes and/or is point features (e.g., a hospital, a library and/or any point within a location). For a point feature, it can be moved to the closest vector map segment. In some embodiments, each point feature is moved to the closest segment every 100 meters along that segment. For example, turning to FIG. 7A and FIG. 7B, FIG. 7A and FIG. 7B show examples of a geographical area with a point feature of a hospital, and moving the hospital to the vector map segment, according to some embodiments of the invention.

In some embodiments, a path can be determined to reachable nodes using a Dijkstra algorithm, as is known in the art. The reachable nodes can be used to determine multiple paths from a first location to each reachable node. For each of the multiple paths, sum the stats along interconnecting segments on the path, and assign the summed to the respective path. Select the path of the multiple path that corresponds to the request as being the path.

For example, assume a request to determine a walking route to a subway stop with the most daycares within a walking distance of 45 minutes from the first location. Dijkstra algorithm can be used to determine reachable nodes (e.g., locations that are reachable within 45 minutes). The number of those paths that have both subway stations and daycare centers can be determined, as described above, by summing the stat of daycare center and the stat of subway station of segments along the path from the starting location to the reachable nodes. The path with a subway station and the most number of daycares can be selected (e.g., second location being the corresponding reachable node used to determine the stats) and output to a display.

In some embodiments, every stat that is determined for each reachable node can be transmitted to the display. In some embodiments, continuing with the example above, a map with the starting location highlighted (e.g., with a person symbol on it) can be displayed and each path can be highlighted with the associated stat displayed next to the path to visualize all of the determined stats (e.g., daycares and subway stops) for all reachable nodes. In some embodiments, only the path is highlighted and the stats are displayed when a cursor is positioned on the path.

FIG. 7C is an example of a display showing the stat of jobs accessible where the trip starts in the cell in a particular geographical region, according to some embodiments of the invention. FIG. 7D is an example of the display of FIG. 7C with the stat of hospitals accessible where the trip starts in the same cell in the particular geographical region, according to some embodiments of the invention.

In some embodiments, it can be desirable to determine stats only along a walkable path rather than, for example, over an entire geographical region and/or a larger geographical region than the specified reachable path to, for example, reduce the number of computations. In some embodiments, it can be desirable to determine the stats in real-time rather than precompute the stats. For example, for a newly received dataset of stats for a system that is providing output being used in real-time (e.g., stats are related to accessibility to transit).

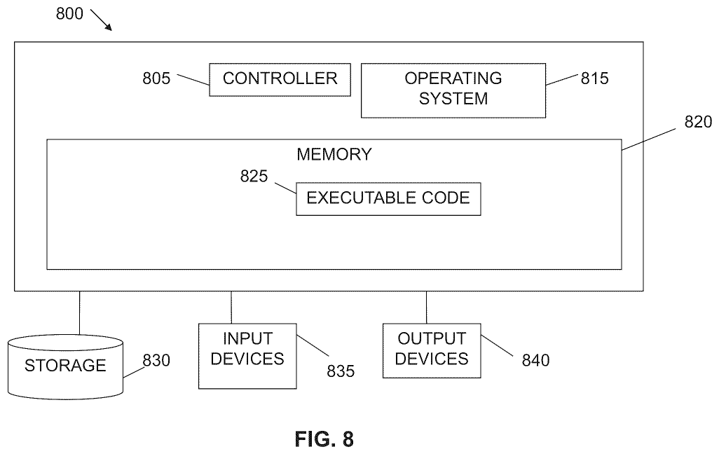

FIG. 8 shows a block diagram of a computing device 800 which can be used with embodiments of the invention. Computing device 800 can include a controller or processor 805 that can be or include, for example, one or more central processing unit processor(s) (CPU), one or more Graphics Processing Unit(s) (GPU or GPGPU), a chip or any suitable computing or computational device, an operating system 815, a memory 820, a storage 830, input devices 835 and output devices 840.

Operating system 815 can be or can include any code segment designed and/or configured to perform tasks involving coordination, scheduling, arbitration, supervising, controlling or otherwise managing operation of computing device 800, for example, scheduling execution of programs. Memory 820 can be or can include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 820 can be or can include a plurality of, possibly different memory units. Memory 820 can store for example, instructions to carry out a method (e.g. code 825), and/or data such as user responses, interruptions, etc.

Executable code 825 can be any executable code, e.g., an application, a program, a process, task or script. Executable code 825 can be executed by controller 805 possibly under control of operating system 815. For example, executable code 825 can when executed cause masking of personally identifiable information (PII), according to embodiments of the invention. In some embodiments, more than one computing device 800 or components of device 800 can be used for multiple functions described herein. For the various modules and functions described herein, one or more computing devices 800 or components of computing device 800 can be used. Devices that include components similar or different to those included in computing device 800 can be used, and can be connected to a network and used as a system. One or more processor(s) 805 can be configured to carry out embodiments of the invention by for example executing software or code. Storage 830 can be or can include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, NN model data, parameters, etc. can be stored in a storage 830 and can be loaded from storage 830 into a memory 820 where it can be processed by controller 805. In some embodiments, some of the components shown in FIG. 8 can be omitted.

Input devices 835 can be or can include for example a mouse, a keyboard, a touch screen or pad or any suitable input device. It will be recognized that any suitable number of input devices can be operatively connected to computing device 800 as shown by block 835. Set of devices 840 can include one or more displays, speakers and/or any other suitable output devices. It will be recognized that any suitable number of output devices can be operatively connected to computing device 800 as shown by block 840. Any applicable input/output (I/O) devices can be connected to computing device 800, for example, a wired or wireless network interface card (NIC), a modem, printer or facsimile machine, a universal serial bus (USB) device or external hard drive can be included in input devices 835 and/or output devices 840.

Embodiments of the invention can include one or more article(s) (e.g. memory 820 or storage 530) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Some embodiments of the present invention may be embodied in the form of a system, a method or a computer program product. Similarly, some embodiments may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with embodiments. In some embodiments the instructions stores on the computer readable medium may be in the form of an installed application and in the form of an installation package.

Such instructions may be, for example, loaded by one or more processors and get executed. For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

1. A method for predicting stats for different destinations, the method comprising:
receiving, by a computing device, a dataset of stats in a spatial format and a request for at a stat, the request including a geographical area;
determining, by the computing device, a grid of cells based on the geographical area;
determining, by the computing device, an origin point in each cell in the grid of cells;
determining, by the computing device, a graph for each cell in the grid of cells, wherein each graph is a collection of nodes and edges based on its respective origin point in its corresponding cell in the grid of cells and vector map data;
determining for each graph, by the computing device, a proportion of the stat to assign to each node, edge or both in the geographical area based on an overlap between the dataset of stats and each respective graph;
determining, by the computing device, a total for the stat for the geographical area; and
transmitting, by the computing device, the graph, and the total to a display.

2. The method of claim 1 wherein the request further comprises a time of day, duration for a trip, one or more mode of transportation or any combination thereof.

3. The method of claim 1 further comprising determining an upper bound for each cell in the grid of cells, wherein the upper bound is a maximum distance from the origin point that can be reached in the respective cell.

4. The method of claim 1 wherein the cell is a hexagonal cell.

5. The method of claim 1 further comprising determining for each origin point in each cell, a duration to get to every other node in the graph.

6. The method of claim 1 wherein the vector map data is retrieved at a predetermined zoom level.

7. The method of claim 2 wherein the stat is user selectable.

8. The method of claim 1 further comprising receiving a plurality of stats, wherein the stat and the plurality of stats include population count, jobs count, percentage of a population under poverty line, percentage of population in particular age group, percentage of population that is part of a particular ethnicity, or any combination thereof.

9. A system for predicting stats for different destinations, the system comprising:
a processor configured to:
receive a dataset of stats in a spatial format and a request for at a stat, the request including a geographical area;
determine a grid of cells based on the geographical area;
determine an origin point in each cell in the grid of cells;
determine a graph for each cell in the grid of cells, wherein the graph is a collection of nodes and edges based on its respective origin point in its corresponding cell in the grid of cells and vector map data;
determine, for each graph, a proportion of the stat to assign to each node, edge or both in the geographical area based on an overlap between the dataset of stats and each respective graph;
determine a total for the stat for the geographical area; and
transmit the graph, and the total to a display.

10. The system of claim 1 wherein the request further comprises a time of day, duration for a trip, one or more mode of transportation or any combination thereof.

11. The system of claim 1 wherein the processor is further configured to determine an upper bound for each cell in the grid of cells, wherein the upper bound is a maximum distance from the origin point that can be reached in the respective cell.

12. The system of claim 1 wherein the cell is a hexagonal cell.

13. The system of claim 1 wherein the processor is further configured to determine for each origin point in each cell, a duration to get to every other node in the graph.

14. The system of claim 1 wherein the vector map data is retrieved at a predetermined zoom level.

15. The system of claim 1 wherein the stat is user selectable.

16. The system of claim 1 wherein the processor is further configured to receive a plurality of stats, wherein the stat and the plurality of stats include population count, jobs count, percentage of a population under poverty line, percentage of population in particular age group, percentage of population that is part of a particular ethnicity, or any combination thereof.
